(19) United States
(12) Patent Application Publication
(10) Pub. No.: US 2023/0145120 A1
(43) Pub. Date: May 11, 2023

(54) STATIC-PROOF WATER-BASED PROTECTIVE FILM AND PREPARATION METHOD THEREOF

(71) Applicant: CLOUD NETWORK TECHNOLOGY SINGAPORE PTE. LTD., Singapore (SG)

(72) Inventors: CHIA-HUNG YANG, New Taipei (TW); TIEN-HSIEN WANG, New Taipei (TW); WEI-HSIANG LIU, New Taipei (TW); CHING-FU HSIEH, New Taipei (TW)

(21) Appl. No.: 17/722,490

(22) Filed: Apr. 18, 2022

(30) Foreign Application Priority Data
Nov. 9, 2021 (CN) 202111318888.X

(51) Int. Cl. C09D 175/08

(52) U.S. Cl. CPC C09D 175/08

(57) ABSTRACT

A water-based protective film which is largely immune to static electricity includes 60 to 70 parts of a water-based polyurethane by weight, 12 to 17 parts of an emulsion dispersant by weight, 3 to 8 parts of an antistatic agent by weight, and 10 to 20 parts of water by weight. A preparation method of the water-based protective film is also disclosed, the water-based protective film, which is in a form of slurry before drying, can be applied to an object surface by spraying, by immersion, or by brushing.

### FIELD

The subject matter herein generally relates to the field of polymer materials, and more particularly, to a removable water-based protective film with an antistatic property and a method of preparing the protective film.

### BACKGROUND

A spray-type, removable protective film is applied on the paint of a vehicle, which can prevent the paint from being scratched or worn. Such protective film is also used for other objects such as furniture, metal, glass, ceramics, wood products, and plastics to avoid scratches or adhesion of dirt. In addition, the protective film can be directly removed to expose the clean surface of the object. However, the protective film lacks immunity to static electricity, thus preventing its application in electronic products or other fields that require anti-static properties. Furthermore, the protective film cannot be applied on a curved surface.

### BRIEF DESCRIPTION OF THE DRAWINGS

Implementations of the present disclosure will now be described, by way of embodiments only, with reference to the attached figures.

FIG. 1 is a flow chart of a method for preparing a water-based protective film according to an embodiment of the present disclosure.

FIG. 2 showing different steps of applying the water-based protective film of FIG. 1 to an electronic product.

### DETAILED DESCRIPTION

Unless otherwise defined, all technical and scientific terms used herein have the same meaning as commonly understood by persons skill in the art. The terms used herein are only for the purpose of describing specific embodiments, and not intended to limit the embodiments of the present application.

In this application, descriptions such as “first”, “second” etc. are only used for description purposes and should not be understood as indicating or implying their relative importance or implying the number of indicated technical features. Thus, a feature defined as “first” and “second” may expressly or implicitly include at least one of that features. In the description of the present application, “plurality” means more than one unless expressly and specifically defined otherwise.

Some embodiments of the present application will be described in detail below with reference to the drawings. The following embodiments and features of the embodiments may be combined with each other in the absence of conflict.

An embodiment of the present disclosure provides a water-based protective film, which includes 60 to 70 parts of a water-based polyurethane by weight, 12 to 17 parts of an emulsion dispersant by weight, 3 to 8 parts of an antistatic agent by weight, and 10 to 20 parts of water by weight.

The water-based polyurethane serves as a base material of the water-based protective film. The antistatic agent is added to increase an antistatic property of the water-based protective film. The water-based protective film has a good film-forming property and excellent antistatic performance, is strong in tension, and is also safe and environmentally friendly.

In some embodiments, the water-based protective film includes 70 parts of the water-based polyurethane by weight, 17 parts of the emulsion dispersant by weight, 3 parts of the antistatic agent by weight, and 10 parts of water by weight.

In some embodiments, the water-based protective film includes 65 parts of the water-based polyurethane by weight, 15 parts of the emulsion dispersant by weight, 5 parts of the antistatic agent by weight, and 15 parts of water by weight.

In some embodiments, the water-based protective film includes 60 parts of the water-based polyurethane by weight, 12 parts of the emulsion dispersant by weight, 8 parts of the antistatic agent by weight, and 20 parts of water by weight.

In some embodiments, the water-based polyurethane may be a prepolymer of diphenylmethane diisocyanate (MDI, chemical formula C₁₅H₁₀N₂O₂) and polyether polyol. The water-based polyurethane is a dispersion of anionic aliphatic water-based polyurethane, which is dissolved and diluted with water.

The polyether polyol is prepared from one or more alkylene oxides with 2 to 4 carbon atoms in the alkylene and a first component containing 2 or 3 active hydrogens. The alkylene oxides include, but are not limited to, tetrahydrofuran, propylene oxide, and so on. Starter molecules include, but are not limited to, water, dicarboxylic acid, ethylene glycol, propylene glycol, resorcinol, hydroquinone, glycerol, trimethylolpropane, etc. The use of MDI and polyether polyol in the preparation of the water-based polyurethane does not lead to early crosslinking or gelation, so the prepared water-based polyurethane has a suitable and necessary viscosity. Thus, the slurry obtained in the subsequent process can be solidified into a removable film.

In some embodiments, the emulsion dispersant may include, but is not limited to, polyether-modified polydimethylsiloxanes (also known as carbinol (Hydroxyl) Terminated PolyDimethylsiloxanes, CAS No.: 68937-54-2) and the like. The polyether-modified polydimethylsiloxane includes a siloxane main chain and a polyether chain. The siloxane main chain acts as a hydrophobic group, which gives the water-based protective film excellent stability, anti-aging, and softness and pliability. The hydrophilic polyether chain makes the water-based protective film to have good surface activity. By changing the type, quantity, and position of the polyether, the polyether-modified polydimethylsiloxane can adjust the hydrophilic and lipophilic properties, so as to obtain different properties such as emulsifying, dispersing, and defoaming, so that other components can be uniformly emulsified and dispersed in a solvent to obtain a homogeneous slurry.

In some embodiments, the antistatic agent may include, but is not limited to, amodimethicone (CAS No.: 71750-80-6). The amodimethicone is an aminosilicon polymer surfactant that provides antistatic property to the water-based protective film. Specifically, during the drying and polymerization process of the protective film, the amodimethicone migrates to the surface. After the protective film is dried, the antistatic molecules (i.e., amodimethicone) cover the surface, and the hydrophilic groups of the amodimethicone in contact with air attract moisture, effectively preventing the accumulation of static electricity.

If the amount of the amodimethicone in the protective film is too small, the antistatic property will be insufficient; if the amount of the amodimethicone in the protective film is too large, the effect of improving the surface resistance will be limited, and the relative amount of the water-based polyurethane will be reduced, which will affect the film-forming property. In the present application, the amodimethicone (antistatic agent) is 3 parts to 8 parts by weight, and the water-based polyurethane is 60 parts to 70 parts by weight, which not only ensures the antistatic effect, but also ensures the film-forming property.

In some embodiments, the surface resistance of the water-based protective film is 10⁹ ohms to 10¹⁰ ohms. Materials with a surface resistance greater than 10¹² ohms are insulating materials, materials with a surface resistance less than 10⁵ ohms are conductive materials, and materials with a surface resistance between 10⁵ ohms and 10¹² ohms dissipate static. The surface resistance of the water-based protective film of the present application is 10⁹ ohms to 10¹⁰ ohms, indicating that the water-based protective film has good antistatic ability.

In some embodiments, the water-based protective film may further include water-soluble pigments, and the water-soluble pigments are 5 parts to 10 parts by weight. For example, the water-soluble pigment may be brilliant blue (also known as bis[4-(N-ethyl-N-3-sulfobenzyl)aminophenyl]-2-sulfonic acid tolyl disodium salt, CAS No.: 3844-45-9) to make the water-based protective film blue. In other embodiments, the brilliant blue may be replaced with other water-soluble pigments to allow different colors of the water-based protective films.

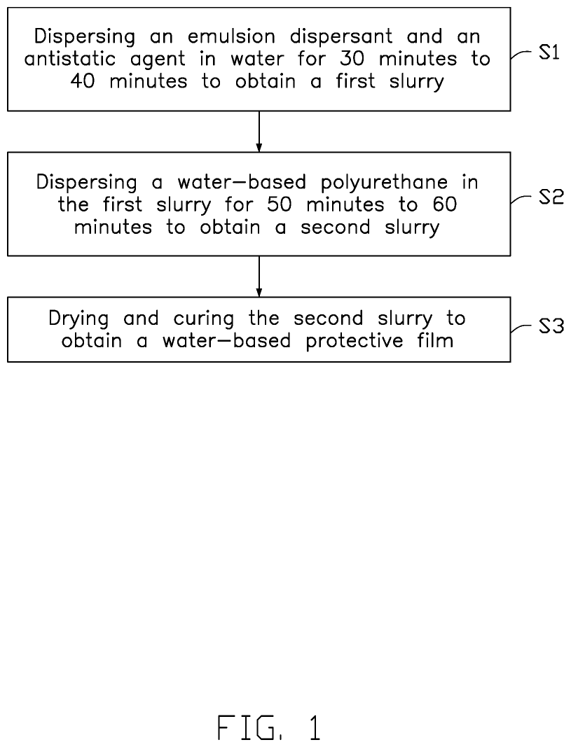

Referring to FIG. 1, the present application also provides a preparation method for the above-mentioned water-based protective film, which includes the following steps:

S1: an emulsion dispersant and an antistatic agent are added into water, and dispersed at room temperature for 30 minutes to 40 minutes to obtain a first slurry. The room temperature is about 20 degrees Celsius to 30 degrees Celsius.

S2: a water-based polyurethane is added into the first slurry and dispersed at room temperature for 50 minutes to 60 minutes to obtain a second slurry.

S3: the second slurry is dried to obtain the water-based protective film.

The numbering of the steps is intended to describe the preparation method, but is not intended to limit the sequence of the steps.

In some embodiments, in step S3, the second slurry is dried by heating at a temperature of 70 degrees Celsius to 90 degrees Celsius for a period of 3 minutes to 10 minutes.

Furthermore, in some embodiments, the second slurry is heated at a temperature of 80 degrees Celsius, and a period of 5 minutes.

In some embodiments, before heating the second slurry, the second slurry may be first dried with cooled air for about 5 minutes.

In some embodiments, in step S2, a water-soluble pigment may be added to obtain the second slurry.

The water-based protective film described in the present application can be used in the assembly process of an electronic product. During the assembly process of the electronic product, some components or a housing of the electronic product are loaded in to a fixture. However, the surfaces of the components or the housing may be scratched. The water-based protective film can be set on the surfaces of the fixture to protect the components or the housing from being scratched, and to avoid electrostatic accumulation on the components or in the housing.

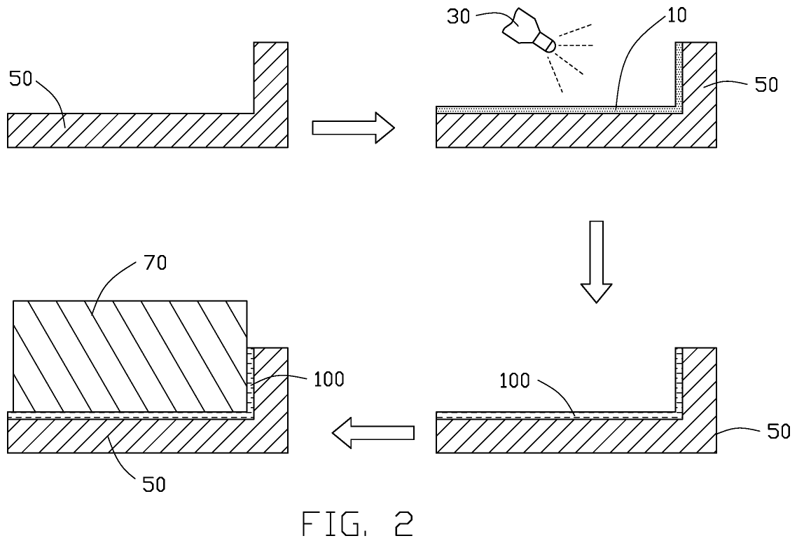

Referring to FIG. 2, a second slurry 10 (which may also include a water-soluble pigment) prepared from polyether-modified polydimethylsiloxane, amodimethicone, water, and the water-based polyurethane is loaded into a spray gun 30. Then, the second slurry 10 is evenly sprayed on the surface of a fixture 50 by the spray gun 30, and dried in cooled air for 5 minutes and then heated at 80 degrees Celsius for 5 minutes. After heating, the second slurry 10 is maintained at room temperature for 5 minutes to obtain a water-based protective film 100. The water-based protective film 100 is anti-static, dust-proof, waterproof, oil-proof, dirt-proof, scratch-proof, and environmentally friendly. The water-based protective film 100 does not damage the fixture 50 or components 70, and can be easily removed when needed. Since the gap between the fixture 50 and the components 70 is approximately 150 μm±50 the thickness of the water-based protective film 100 in this embodiment may be 75 μm±25 μm. In other application scenarios, the thickness of the water-based protective film 100 can be set as required.

### Example 1

S1: 17 parts of polyether-modified polydimethylsiloxane (emulsion dispersant) by weight, 3 parts of amodimethicone (antistatic agent) by weight, and 10 parts of water by weight were added into a mixer and dispersed at room temperature for 30 minutes to obtain a first slurry.

S2: 70 parts of water-based polyurethane by weight were added to the first slurry and dispersed at room temperature for 55 minutes to obtain a second slurry.

S3: the second slurry was dried in cooled air for 5 minutes, and then heated to a temperature of 80 degrees Celsius for 5 minutes. After heating, the second slurry was kept at room temperature for 5 minutes to obtain a water-based protective film.

The surface resistance of the water-based protective film prepared in this example was tested with a surface resistance meter, and the test result was 10¹⁰ ohms.

### Example 2

S1: 15 parts of polyether-modified polydimethylsiloxane (emulsion dispersant) by weight, 5 parts of amodimethicone (antistatic agent) by weight, and 15 parts of water by weight were added into a mixer and dispersed at room temperature for 40 minutes to obtain a first slurry.

S2: 65 parts of water-based polyurethane by weight were added to the first slurry and dispersed at room temperature for 55 minutes to obtain a second slurry.

S3: the second slurry was heated at a temperature of 90 degrees Celsius for 3 minutes. After heating, the second slurry was kept at room temperature for 5 minutes to obtain a water-based protective film.

The surface resistance of the water-based protective film prepared in this example was tested with a surface resistance meter, and the test result was 10⁹ ohms.

### Example 3

S1: 12 parts of polyether-modified polydimethylsiloxane (emulsion dispersant) by weight, 8 parts of amodimethicone (antistatic agent) by weight, and 20 parts of water by weight were added into a mixer and dispersed at room temperature for 35 minutes to obtain a first slurry.

S2: 60 parts of water-based polyurethane by weight were added to the first slurry and dispersed at room temperature for 60 minutes, and 5 parts of brilliant blue (water-soluble pigment) by weight were added to obtain a second slurry.

S3: the second slurry was heated at a temperature of 70 degrees Celsius for 10 minutes. After heating, the second slurry was kept at room temperature for 5 minutes to obtain a water-based protective film.

The surface resistance of the water-based protective film prepared in this example was tested with a surface resistance meter, and the test result was 10⁹ ohms.

### Comparative Example 1

S1: 20 parts of polyether-modified polydimethylsiloxane (emulsion dispersant) by weight and 15 parts of water by weight were added into a mixer and dispersed at room temperature for 30 minutes to obtain a first slurry.

S2: 65 parts of water-based polyurethane by weight were added to the first slurry and dispersed at room temperature for 55 minutes to obtain a second slurry.

S3: the second slurry was heated at a temperature of 80 degrees Celsius for 5 minutes. After heating, the second slurry was kept at room temperature for 5 minutes to obtain a water-based protective film.

The surface resistance of the water-based protective film prepared in this comparative example was tested with a surface resistance meter, and the test result was 10¹² ohms.

The amount of each component and the surface resistance of each water-based protective film in the above Examples 1-3 and Comparative Example 1 are shown in Table 1.

TABLE 1

| | | | | Comparative |
|---|---|---|---|---|
| | Example 1 | Example 2 | Example 3 | Example 1 |
| water-based | 70 | 65 | 60 | 65 |
| polyurethane | | | | |
| (parts by weight) | | | | |
| emulsion dispersant | 17 | 15 | 12 | 20 |
| (parts by weight) | | | | |
| antistatic agent | 3 | 5 | 8 | 0 |
| (parts by weight) | | | | |
| water | 10 | 15 | 20 | 15 |
| (parts by weight) | | | | |
| water-soluble pigment | 0 | 0 | 5 | 0 |
| (parts by weight) | | | | |
| surface resistance | 10¹⁰ | 10⁹ | 10⁹ | 10¹² |
| (ohms) | | | | |

According to the results of Examples 1-3 and Comparative Example 1, the surface resistance of the water-based protective films prepared in Examples 1-3 ranges from 10⁹ ohms to 10¹⁰ ohms, indicating that the water-based protective film has excellent antistatic performance. In Comparative Example 1, the surface resistance of the water-based protective film is large (10¹² ohms) due to the absence of the antistatic agent, therefore the water-based protective film prepared in Comparative Example 1 has no antistatic effect.

In the present disclosure, the water-based polyurethane serves as a base material of the water-based protective film, an antistatic agent is added to increase antistatic property of the water-based protective film, and the ratios for additions of the substrate, the antistatic agent, and the emulsion dispersant are adjusted to obtain the water-based protective film. The water-based protective film has advantages of good film-forming property, excellent antistatic performance, strong under tension, and is easily removed. Moreover, the water-based protective film described in the present application is in the form of slurry before drying, thus application onto an object surface can be by spraying, impregnation, or brushing, so as to be fit well to the object surface and not be limited by the shape and size of the object, the application scene is more flexible. In addition, the water-based protective film described in the present application uses water as a solvent, which is environmentally friendly, has no volatile organic compounds (VOC), does not harm operators or objects, and can adjust the color according to needs.

The above descriptions are some specific embodiments of the present application, but the actual application process cannot be limited only to these embodiments. For those of ordinary skill in the art, other modifications and changes made according to the technical concept of the present application should all belong to the protection scope of the present application.

What is claimed is:

1. A water-based protective film, comprising:
60 to 70 parts of a water-based polyurethane by weight;
12 to 17 parts of an emulsion dispersant by weight;
3 to 8 parts of an antistatic agent by weight; and
10 to 20 parts of water by weight.

2. The water-based protective film of claim 1, wherein the water-based polyurethane is a prepolymer of diphenylmethane diisocyanate and polyether polyol.

3. The water-based protective film of claim 1, wherein the emulsion dispersant comprises polyether-modified polydimethylsiloxane.

4. The water-based protective film of claim 1, wherein the antistatic agent comprises amodimethicone.

5. The water-based protective film of claim 1, wherein a surface resistance of the water-based protective film is 10⁹ ohms to 10¹⁰ ohms.

6. The water-based protective film of claim 1, further comprising 5 to 10 parts of a water-soluble pigment by weight.

7. A preparation method for a water-based protective film, comprising:
dispersing an emulsion dispersant and an antistatic agent in water for 30 minutes to 40 minutes to obtain a first slurry;
dispersing a water-based polyurethane in the first slurry for 50 minutes to 60 minutes to obtain a second slurry; and
drying the second slurry to obtain the water-based protective film.

8. The preparation method of claim 7, wherein the second slurry is dried by heating the second slurry at a temperature of 70 degrees Celsius to 90 degrees Celsius for a period of 3 minutes to 10 minutes.

9. The preparation method of claim 8, wherein the temperature is 80 degrees Celsius, and the period is 5 minutes.

10. The preparation method of claim 7, wherein after the water-based polyurethane is dispersed in the first slurry, the preparation method further comprises adding a water-soluble pigment into the first slurry.
